(19) United States
(12) Patent Application Publication
(10) Pub. No.: US 2026/0214006 A1
(43) Pub. Date: Jul. 23, 2026

(54) SPECTRUM CHANNEL ALLOCATION FOR SATELLITE BACKHAUL TRANSPORT IN MOBILE NETWORKS

(71) Applicants: AT&T Intellectual Property I, L.P., Atlanta, GA (US); AT&T Communications Services India Private Limited, Bangalore (IN)

(72) Inventors: Mritunjay Pandey, Bangalore (IN); Subhash Kapoor, Wall, NJ (US); Saurav Paira, Kendall Park, NJ (US)

(21) Appl. No.: 19/032,402

(22) Filed: Jan. 20, 2025

(51) Int. Cl. H04L 41/08; H04B 7/185; H04L 41/16

(52) U.S. Cl. CPC H04L 41/0883; H04B 7/18543; H04L 41/16

(57) ABSTRACT

A method includes determining a demand on a mobile network that utilizes a satellite backhaul transport network, acquiring a set of values for parameters of the satellite backhaul transport network, executing a machine learning model that takes the demand and the set of values as an input and generates as an output a recommended configuration of the satellite backhaul transport network, presenting the recommended configuration to an operator of the mobile network, and modifying, in response to an acceptance of the recommended configuration by the operator, a configuration of the satellite backhaul transport network in accordance with the recommended configuration.

The present disclosure relates generally to mobile networks and relates more particularly to devices, non-transitory computer-readable media, and methods for allocating a radio frequency spectrum channel for satellite backhaul transport in mobile networks.

### BACKGROUND

In the mobile networking field, backhaul refers to the part of a network that functions as an intermediary between the core network and the access networks (or other sub-networks) connected to the core network. In fifth generation (5G) cellular networks, backhaul is increasingly being provided using satellite networks in order to better support the unique latency, bandwidth, density, and other network demands of the 5G networks. For instance, satellites may connect to the core network (e.g., to a satellite gateway device in the core network) as well as to the cellular base stations (e.g., gNodeBs in 5G networks), thereby providing a bridge between the core network and the cellular base stations.

### SUMMARY

In one example, the present disclosure describes a device, computer-readable medium, and method for allocating a radio frequency spectrum channel for satellite backhaul transport in a mobile network. For instance, in one example, a method includes determining a demand on a mobile network that utilizes a satellite backhaul transport network, acquiring a set of values for parameters of the satellite backhaul transport network, executing a machine learning model that takes the demand and the set of values as an input and generates as an output a recommended configuration of the satellite backhaul transport network, presenting the recommended configuration to an operator of the mobile network, and modifying, in response to an acceptance of the recommended configuration by the operator, a configuration of the satellite backhaul transport network in accordance with the recommended configuration.

In another example, a non-transitory computer-readable medium stores instructions which, when executed by a processor, cause the processor to perform operations. The operations include determining a demand on a mobile network that utilizes a satellite backhaul transport network, acquiring a set of values for parameters of the satellite backhaul transport network, executing a machine learning model that takes the demand and the set of values as an input and generates as an output a recommended configuration of the satellite backhaul transport network, presenting the recommended configuration to an operator of the mobile network, and modifying, in response to an acceptance of the recommended configuration by the operator, a configuration of the satellite backhaul transport network in accordance with the recommended configuration.

In another example, a device includes a processor and a computer-readable medium storing instructions which, when executed by the processor, cause the processor to perform operations. The operations include determining a demand on a mobile network that utilizes a satellite backhaul transport network, acquiring a set of values for parameters of the satellite backhaul transport network, executing a machine learning model that takes the demand and the set of values as an input and generates as an output a recommended configuration of the satellite backhaul transport network, presenting the recommended configuration to an operator of the mobile network, and modifying, in response to an acceptance of the recommended configuration by the operator, a configuration of the satellite backhaul transport network in accordance with the recommended configuration.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for training a machine learning model to allocate a radio frequency spectrum channel for satellite backhaul transport in a mobile network, in accordance with the present disclosure;

FIG. 3 illustrates a flowchart of an example method for allocating a radio frequency spectrum channel for satellite backhaul transport in a mobile network, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure allocates radio frequency spectrum channels for satellite backhaul in mobile networks. As discussed above, backhaul is increasingly being provided in 5G cellular networks, using satellite networks in order to better support the unique latency, bandwidth, density, and other network demands of the 5G networks. For instance, satellites may connect to the core network (e.g., to a satellite gateway device in the core network) as well as to the cellular base stations (e.g., gNodeBs in 5G networks), thereby providing a bridge between the core network and the cellular base stations.

The wireless signal strength between the satellites and the cellular base stations, as well as between the satellites and the core network, may be affected by many conditions. This conditions may include, for example, the physical distance between the satellites and the cellular base stations, the physical distance between the satellites and the core network, gain profiles, absorption losses, scattering (e.g., Rayleigh scattering, Mie scattering, or the like), dispersion profiles, and air interface characteristics. These conditions may make it a challenge, when launching a new spectrum channel of the mobile network to support increased network demand, to identify the optimum number of channels and the locations for these channels. Conventional mobile access networks are not equipped with the capability to determine these conditions across the entire access network and to configure a satellite backhaul transport network accordingly.

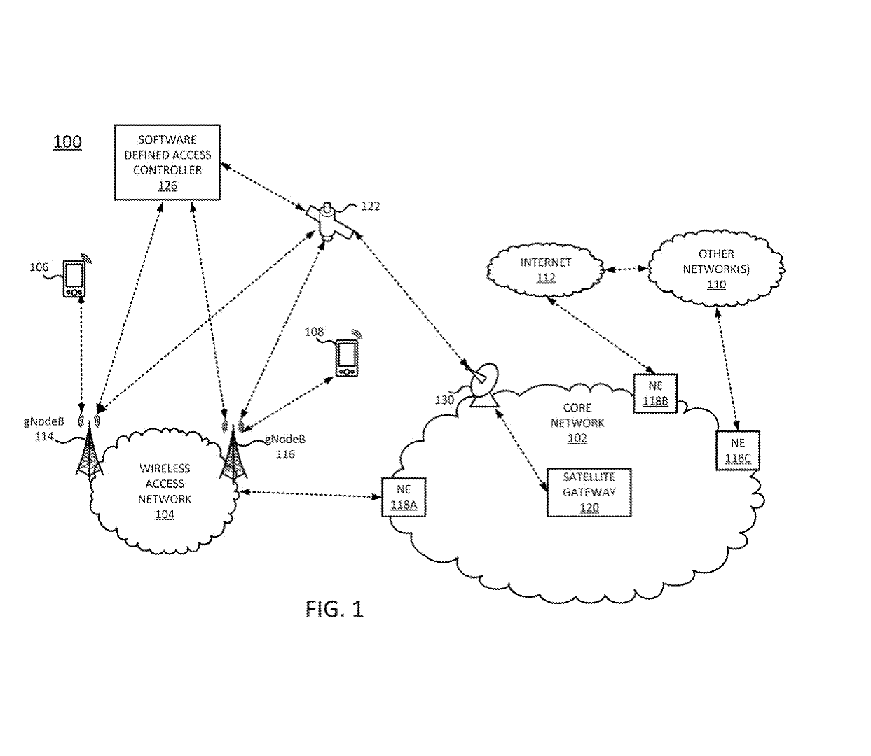

Examples of the present disclosure deploy a software defined access controller (SDAC) in a mobile network that includes a satellite backhaul transport network. The SDAC includes a machine learning model that is trained to learn the impacts the variations in conditions such as those described above may have on supporting network demand. The machine learning model may then be trained to recommend an optimal configuration for the satellite backhaul transport network (e.g., numbers and locations of new spectrum channels) to support a given network demand, given a set of conditions in the mobile network. Thus, when there is a temporary increase in network demand, as there may be during events such as global sporting events (e.g., Olympics, World Cup, etc.), holidays, natural disasters, and other types of events, a configuration of the satellite backhaul transport network may be automatically recommended and/or implemented to provide the bandwidth needed to support the increase in demand. The machine learning model may also recommend optimal configurations for the satellite backhaul transport network to handle more cyclic changes in network demand (e.g., certain times of day where demand is observed to increase or decrease). These and other aspects of the present disclosure are discussed in greater detail in connection with FIGS. 1-4, below.

To better understand the present disclosure, FIG. 1 illustrates an example network 100, related to the present disclosure. As shown in FIG. 1, the network 100 connects mobile devices 106 and 108, as well as potentially other devices, with one another and with various other devices via a core network 102, a wireless access network 104 (e.g., a cellular network), other networks 110 and/or the Internet 112.

In one example, wireless access network 104 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 104 may comprise an access network in accordance with any “second generation” (2G), “third generation” (3G), “fourth generation” (4G), Long Term Evolution (LTE), “fifth generation” (5G), next‐generation radio access network (NG‐RAN), or any other yet to be developed future wireless/cellular network technology including beyond 5G, e.g., 6G and further generations. While the present disclosure is not limited to any particular type of wireless access network, in the illustrative example, wireless access network 104 is shown as a UMTS terrestrial radio access network (UTRAN) subsystem. Thus, elements 114 and 116 may each comprise a next generation Node B (gNodeB).

In one example, each of the mobile devices 106 and 108 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, and the like. In one example, any one or more of mobile devices 106 and 108 may have both cellular and non-cellular access capabilities and may further have wired communication and networking capabilities.

As illustrated in FIG. 1, network 100 includes a core network 102. In one example, core network 102 may combine core network components of a cellular network with components of a triple play service network; where triple play services include telephone services, Internet services and television services to subscribers. For example, core network 102 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network. The network elements 118A-118C may serve as gateway servers or edge routers to interconnect the core network 102 with other networks 110, Internet 112, wireless access network 104, other access networks, and so forth. The core network 102 may also comprise a satellite gateway 120 as part of a satellite backhaul transport network. For ease of illustration, various additional elements of core network 102 are omitted from FIG. 1. For instance, core network 102 may also include other network elements that are not illustrated, such as television (TV) servers, content servers, application servers, and the like.

In addition, the network 100 may include a satellite backhaul transport network that functions as an intermediary between the core network 102 and the wireless access network 104, as well as optionally functioning as an intermediary between the other networks 110, the Internet 112, and any other access networks connected to the core network 102. The satellite backhaul transport network may generally comprise the satellite gateway 120 located in the core network 102, a satellite ground station 130 also located in the core network 102 and communicatively coupled to the satellite gateway 120, and a satellite 122. In one example, the satellite 122 may be controlled and/or operated by a same network service provider as the core network 102. In another example, the satellite 122 may be controlled and/or operated by a different entity than the network service provider who operates the core network 102.

In addition, the network 100 may comprise a software defined access controller (SDAC) 126. In one example, the SDAC 126 may be configured to discover the topology of the network 100, including all network elements and all links between the network elements. The SDAC 126 may also collect data from the satellite backhaul transport network and utilize the data to train a machine learning model. Once the machine learning model is trained, the SDAC 126 may execute the machine learning model to generate recommended configurations of the satellite backhaul transport network. For instance, based on inputs relating to actual or predicted demand on the network 100, the machine learning model may generate a recommended configuration of the satellite backhaul transport network to support the demand, where the recommended configuration may include a number of new radio frequency spectrum channels to deploy and locations in which to deploy the new radio frequency spectrum channels (e.g., between the gNodeBs 114 and 116 and the satellite 122 or between the satellite 122 and the ground station 130 or satellite gateway 120).

In further examples, the SDAC 126 may recommend a modulation format for the new radio frequency spectrum channels (e.g., adaptive forward error correction, coherent multiple input, multiple output receiver, flexible data rate, flexible data type, or the like). Thus, the SDAC 126 may recommend a number of new radio frequency spectrum channels and locations for the new radio frequency spectrum channels, as well as tune the new radio frequency spectrum channels and bandwidth to optimize the reachability between the gNodeBs 114 and 116 and the core network satellite gateway 120. In other examples, the SDAC may recommend a modification to a configuration of an existing radio frequency spectrum channel to better support network demand.

In further examples still, the SDAC 126 may be configured to deliver control signals to one or more of the gNodeBs 114 and 116, the satellite 122, the ground station 130, and the satellite gateway 120 to cause the one or more of the gNodeBs 114 and 116, the satellite 122, the ground station 130, and the satellite gateway 120 to perform an action to deploy a new radio frequency spectrum channel having a specified configuration, or to modify a configuration of an existing radio frequency spectrum channel.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Wireless access network 104 is not limited to a UMTS/UTRAN configuration. Similarly, the present disclosure is not limited to an IP/MPLS network for VoIP telephony services, or any particular type of broadcast television network for providing television services, and so forth.

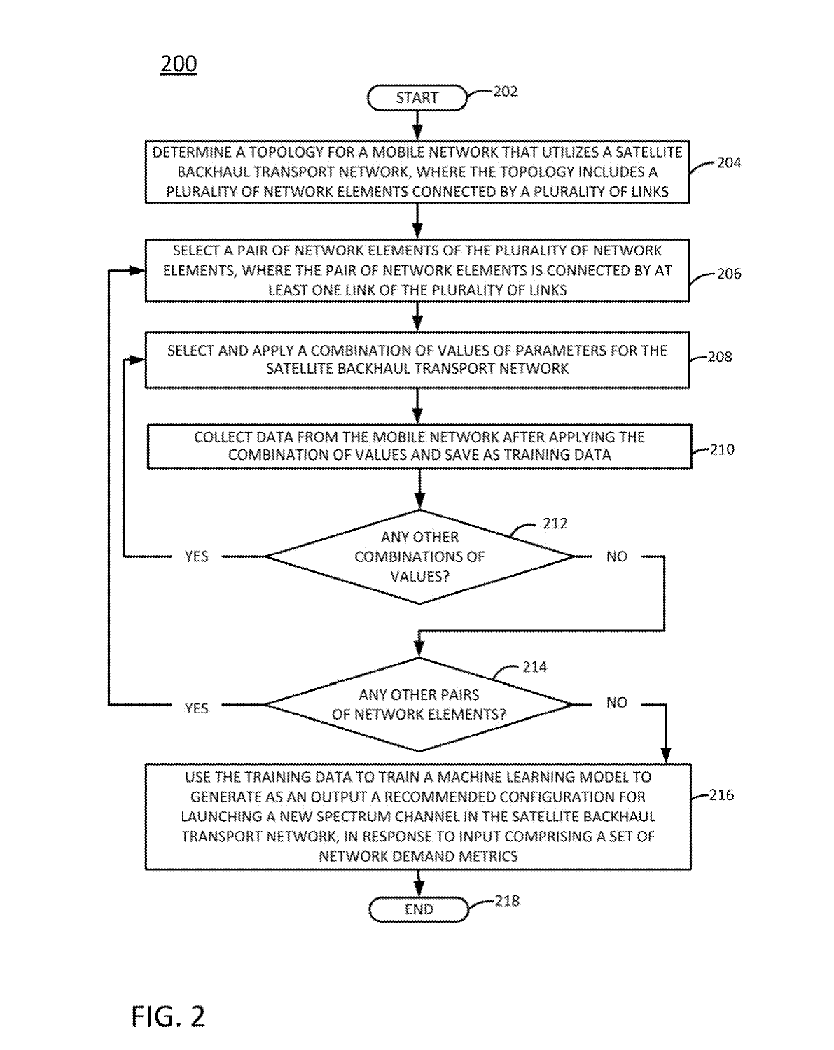

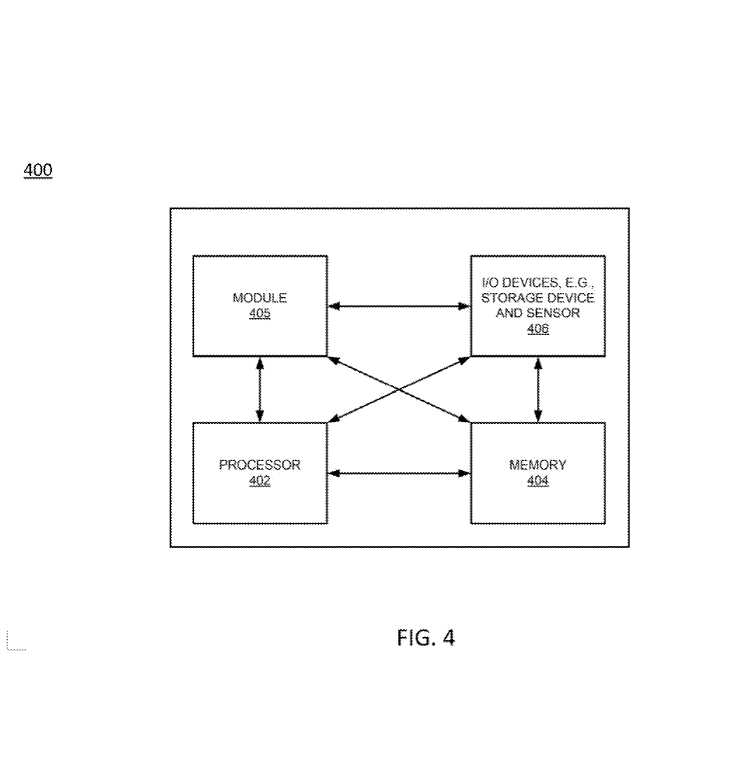

To further aid in understanding the present disclosure, FIG. 2 illustrates a flowchart of an example method 200 for training a machine learning model to allocate a radio frequency spectrum channel for satellite backhaul transport in a mobile network, in accordance with the present disclosure. In one example, the method 200 may be performed by a software-defined access controller, such as the SDAC 126 illustrated in FIG. 1. However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may construct a topology for a mobile network that utilizes a satellite backhaul transport network, where the topology includes a plurality of network elements connected by a plurality of links.

In one example, the mobile network may be a radio frequency network, such as a 5G cellular network. The mobile network may utilize a particular radio frequency spectrum band to deliver mobile network services to user endpoint devices in the mobile network. For instance, in a 5G network, possible spectrum bands may include a low-band spectrum (e.g., any spectrum lower than 1 GHz), a mid-band spectrum (e.g., 1 GHz - 6 GHz), and a high-band spectrum (e.g., millimeter wave/24 GHz and higher). Higher bands tend to provide greater 5G coverage and speed; lower bands tend to be less susceptible to interference (e.g., from buildings, geographical features, etc.).

In one example, the plurality of network elements may include user equipment (UEs) such as mobile devices and other user endpoint devices connected to the mobile network, cellular base stations (e.g., eNodeBs in a long term evolution network, or gNodeBs in a 5G network), and access and mobility management functions (AMFs), user plane functions (UPFs), and the like within a telecommunications operator core network of the mobile network and any connected access networks or sub-networks. The plurality of network elements may also include components of the satellite backhaul transport network, such as one or more satellites and a core network satellite gateway that connects the mobile network’s core network to the one or more satellites.

In step 206, the processing system may select a pair of network elements of the plurality of network elements, wherein the pair of network elements is connected by at least one link of the plurality of links.

In one example, the processing system may go through the topology that is constructed in step 204 one pair of network elements at a time, and may analyze the performance of each route between each pair of network elements under a plurality of different configurations of the satellite backhaul transport network, as discussed in greater detail below. Thus, the method 200 may perform multiple iterations of step 206 and the following steps; however, each time step 206 is performed, a different pair of network elements may be selected.

In step 208, the processing system may select and apply a combination of values for parameters for the satellite backhaul transport network. In one example, the parameters for which values may be selected in step 208 may include parameters whose values may affect the wireless signal strength between the satellite backhaul transport network’s satellites and cellular base stations, as well as the wireless signal strength between the satellite backhaul transport network’s satellites and the mobile network’s core network (e.g., the core network satellite gateway). For instance, in one example, the parameters for which values may be selected in step 208 may include at least one of: a distance between a cellular base station and a satellite, a distance between a satellite and a core network satellite gateway, a gain profile, an absorption loss, scattering (e.g., Rayleigh scattering, Mie scattering, or the like), a dispersion profile, or an air interface characteristic. Air interface characteristics may vary with seasonal and weather-related changes, and changes in air interface characteristics may impact existing spectrum channels as well as present challenges when launching new spectrum channels. For instance, the addition of more high capacity spectrum channels may cause refractive index changes due to nonlinearity. Noise changes may also occur due to increased amplification needs.

As with step 206, the method 200 may perform multiple iterations of step 208 and the following steps; however, each time step 208 is performed, a different combination of values may be selected and applied. Thus, as discussed above, the processing system may analyze the performance of each route between each pair of network elements under a plurality of different configurations (i.e., different combinations of values for the parameters) of the satellite backhaul transport network.

In step 210, the processing system may collect data from the mobile network and add the data collected from the mobile network to a set of training data. In one example, the data collected in step 210 may comprise at least one of: control plane data or data plane data. Thus, for instance, the data collected in step 210 may comprise network traffic volumes (e.g., numbers of packets traversing the mobile network per unit of time), origins and destinations of network traffic (e.g., most frequent origins and destinations, most geographically remote origins and destinations, etc.), sizes of data packets contained in network traffic (e.g., average size, smallest size, largest size, median size, etc.), packet losses, latency, bandwidth, modulation techniques, channel spacing, forward error correction (FEC), peak data rates, connection density, area traffic capacity, network energy efficiency, spectral efficiency, mobility, number of array antennas, throughput, gain profiles, absorption losses, scattering, air interface characteristics, dispersion, seasonality, numbers of hops, distances between network elements, and the like.

In step 212, the processing system may determine whether any other combinations of values for the parameters remain to be applied. As discussed above, the method 200 may perform multiple iterations of step 208 and the following steps; however, each time step 208 is performed, a different combination of values may be selected and applied. In one example, a predefined list of combinations of values may be available, and the processing system may repeat steps 208-210 until each combination of values in the predefined list is applied for the current pair of network elements.

If the processing system determines in step 212 that at least one combination of values for the parameters should still be applied, then the method 200 may return to step 208 and proceed as described above to select, apply, and collect data for another combination of values for the parameters.

If, however, the processing system determines in step 212 that there are no other combinations of values for the parameters that should still be applied, then the method 200 may proceed to step 214. In step 214, the processing system may determine whether any pairs of network elements remain to be analyzed.

As discussed above, the method 200 may perform multiple iterations of step 206 and the following steps; however, each time step 206 is performed, a different pair of network elements may be selected. Thus, steps 206-210 may be repeated for every pair of network elements and every route between every pair of network elements in the mobile network topology.

If the processing system determines in step 214 that at least one pair of network elements should still be analyzed, then the method 200 may return to step 206 and proceed as described above to select another pair of network elements, and then apply and collect data for various combinations of values for the satellite, cellular base station, and core satellite gateway parameters.

If, however, the processing system determines in step 214 that there are no other pairs of network elements to analyze, then the method 200 may proceed to step 216. In step 216, the processing system may use the training data to train a machine learning model to generate as an output a recommended configuration for launching a new spectrum channel in the satellite backhaul transport network, in response to input comprising a set of network demand metrics.

In one example, the machine learning model may comprise an ensemble technique along with a graph neural network (GNN) algorithm. The machine learning model may include a reward and penalty control function enforcement technique to improve the quality of the recommendations. This arrangement may provide superior results relative to other types of machine learning models such as logistic regression, support vector machines, extreme gradient boosting, convolutional neural networks, and artificial neural networks, since the network topology is learned in the form of nodes (network elements) and edges (links).

In one example, the set of network demand metrics may comprise observed network demand metrics derived from control plane and/or data plane data collected in real time from the mobile network (e.g., network traffic volumes (e.g., numbers of packets traversing the mobile network per unit of time), origins and destinations of network traffic, sizes of data packets contained in network traffic, packet losses, latency, bandwidth, and the like), as discussed in greater detail below. In another example, the set of network demands metrics may comprise projected network demand metrics that may be projected based on historical trends in network demand (e.g., seasonal fluctuations in network demand, surges in demand due to holidays or special events, etc.). In other words, the projected network demand metrics may characterize a demand that the network is expected to experience at some specified time in the future.

In one example, the recommended configuration may comprise at least one of: a number of new radio frequency spectrum channels to deploy, a location (e.g., between a gNodeB and a satellite or between a satellite and a core network satellite gateway) at which to deploy a new radio frequency spectrum channel, a modulation format for a new radio frequency spectrum channel (e.g., adaptive forward error correction, coherent multiple input, multiple output receiver, flexible data rate, flexible data type, or the like), a modification to a modulation format of an existing radio frequency spectrum channel, or the like.

In a further example, the recommended configuration may comprise a modification to at least one parameter of the satellite backhaul transport network (e.g., a distance between a cellular base station and a satellite, a distance between a satellite and a core network satellite gateway, a gain profile, an absorption loss, scattering (e.g., Rayleigh scattering, Mie scattering, or the like), a dispersion profile, or an air interface characteristic). The method 200 may end in step 218.

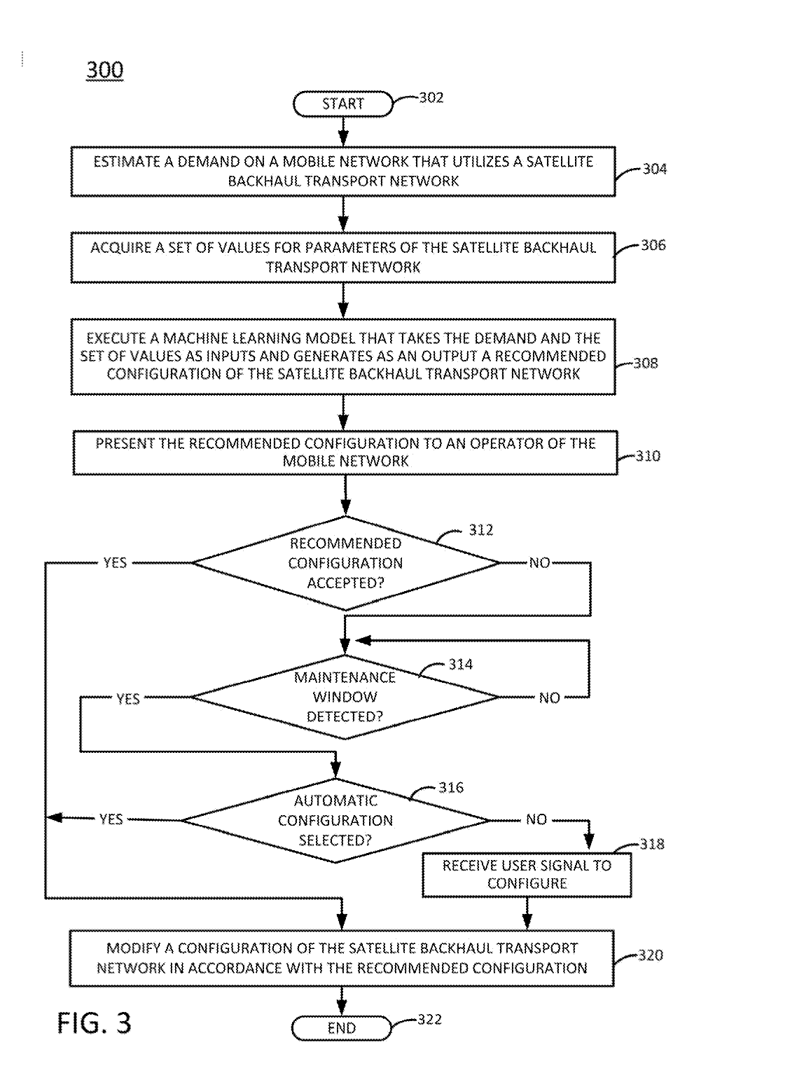

FIG. 3 illustrates a flowchart of an example method 300 for allocating a radio frequency spectrum channel for satellite backhaul transport in a mobile network, in accordance with the present disclosure. In one example, the method 300 may be performed by a software-defined access controller, such as the SDAC 126 illustrated in FIG. 1. However, in other examples, the method 300 may be performed by another device, such as the processor 402 of the system 400 illustrated in FIG. 4. For the sake of example, the method 300 is described as being performed by a processing system.

The method 300 begins in step 302. In step 304, the processing system may determine a demand on a mobile network that utilizes a satellite backhaul transport network.

In one example, the mobile network may be a radio frequency network, such as a 5G cellular network. The mobile network may utilize a particular radio frequency spectrum band to deliver mobile network services to user endpoint devices in the mobile network. For instance, in a 5G network, possible spectrum bands may include a low-band spectrum (e.g., any spectrum lower than 1 GHz), a mid-band spectrum (e.g., 1 GHz - 6 GHz), and a high-band spectrum (e.g., millimeter wave/24 GHz and higher). Higher bands tend to provide greater 5G coverage and speed; lower bands tend to be less susceptible to interference (e.g., from buildings, geographical features, etc.).

In one example, the demand may comprise a real-time demand characterized by one or more metrics measured in the mobile network, such as network traffic volumes (e.g., numbers of packets traversing the mobile network per unit of time), origins and destinations of network traffic, sizes of data packets contained in network traffic, packet losses, latency, bandwidth, and the like. In another example, the demand comprise a projected network demand that may be projected based on historical trends in network demand (e.g., seasonal fluctuations in network demand, surges in demand due to holidays or special events, etc.). In other words, the projected network demand may comprise a demand that the network is expected to experience at some specified time in the future.

In step 306, the processing system may acquire a set of values for parameters of the satellite backhaul transport network. In one example, the parameters for which values may be acquired in step 306 may include parameters whose values may affect the wireless signal strength between the satellite backhaul transport network’s satellites and cellular base stations, as well as the wireless signal strength between the satellite backhaul transport network’s satellites and the mobile network’s core network (e.g., a core network satellite gateway). For instance, in one example, the parameters for which values may be acquired in step 306 may include at least one of: a distance between a cellular base station and a satellite, a distance between a satellite and a core network satellite gateway, a gain profile, an absorption loss, scattering (e.g., Rayleigh scattering, Mie scattering, or the like), a dispersion profile, or an air interface characteristic.

In step 308, the processing system may execute a machine learning model that takes the demand and the set of values as an input and generates as an output a recommended configuration of the satellite backhaul transport network.

In one example, the machine learning model may comprise an ensemble technique along with a graph neural network (GNN) algorithm. The machine learning model may include a reward and penalty control function enforcement technique to improve the quality of the recommendations. This arrangement may provide superior results relative to other types of machine learning models such as logistic regression, support vector machines, extreme gradient boosting, convolutional neural networks, and artificial neural networks, since the network topology is learned in the form of nodes (network elements) and edges (links).

In one example, the recommended configuration may comprise at least one of: a number of new radio frequency spectrum channels to deploy, a location (e.g., between a gNodeB and a satellite or between a satellite and a core network satellite gateway) at which to deploy a new radio frequency spectrum channel, a modulation format for a new radio frequency spectrum channel (e.g., adaptive forward error correction, coherent multiple input, multiple output receiver, flexible data rate, flexible data type, or the like), a modification to a modulation format of an existing radio frequency spectrum channel, or the like. Due to non-linearity and varying gain profiles, the properties of each radio frequency spectrum channel will vary. For instance, no two radio frequency spectrum channels will have exactly the same gain profile, and, hence, may have different reach. However, the recommended configuration takes these variations into account and selects the radio frequency spectrum channels that are best able to provide the reachability and coverage required to support the network demand.

In a further example, the recommended configuration may comprise a modification to at least one parameter of the satellite backhaul transport network (e.g., a distance between a cellular base station and a satellite, a distance between a satellite and a core network satellite gateway, a gain profile, an absorption loss, scattering (e.g., Rayleigh scattering, Mie scattering, or the like), a dispersion profile, or an air interface characteristic).

In step 310, the processing system may present the recommended configuration to an operator of the mobile network. For instance, the processing system may output the recommended configuration via an application executing on a device operated by the operator, using a graphical user interface. In another example, the processing system may send a text- or image-based alert to a device or account associated with the operator (e.g., an email or text message to a mobile phone associated with the operator).

In one example, the presentation of the recommended configuration to the operator may include identifying any expected impacts that deployment of the recommended configuration may have on the mobile network. For instance, deployment of the recommended configuration may have some impact on the mobile network that must be balanced against the improved reachability and coverage provided by the recommended configuration. As an example, deploying the recommended configuration may temporarily disrupt service to some users as one or more components of the satellite backhaul transport network are taken out of service for configuration changes. This disruption may prevent the operator of the mobile network from meeting one or more quality of experience targets. As such, the operator may prefer to postpone deployment of the recommended configuration until a time where the impact in service will be minimized, such as a scheduled maintenance window or a time during which network demand is expected to be low.

In step 312, the processing system may determine whether the operator has accepted the recommended configuration. For instance, as discussed above, deployment of the recommended configuration may have some impact on the mobile network that must be balanced against the improved reachability and coverage provided by the recommended configuration. The operator may not wish to immediately deploy the recommended configuration in order to avoid disruptions to service that may negatively impact users’ quality of experience. As such, the operator may provide some signal indicating that the recommended configuration should be deployed, but that deployment should be postponed to a time at which any service disruptions are likely to minimally impact quality of experience, such as a scheduled maintenance window or a time during which network demand is expected to be low.

If the processing system concludes in step 312 that the operator has accepted the recommended configuration, then the method 300 may proceed to step 320. In step 320, the processing system may modify a configuration of the satellite backhaul transport network in accordance with the recommended configuration.

For instance, modifying the configuration of the satellite backhaul transport network may include deploying one or more new radio frequency spectrum channels in one or more specified locations (e.g., between a gNodeB and a satellite and/or between a satellite and a core network satellite gateway). The modifying may further comprise configuring a modulation format for the one or more new radio frequency spectrum channels (e.g., adaptive forward error correction, coherent multiple input, multiple output receiver, flexible data rate, flexible data type, or the like) and/or modifying a modulation format of an existing radio frequency spectrum channel.

In one example, modifying the configuration may involve sending control signals to one or more components of the satellite backhaul transport network (e.g., to a gNodeB, a satellite, a ground station, and/or a core network satellite gateway), where the control signals cause the one or more components of the satellite backhaul transport network to perform an action to deploy a new radio frequency spectrum channel having a specified configuration, or to modify a configuration of an existing radio frequency spectrum channel

If, however, the processing system concludes in step 312 that the operator has not accepted the recommended configuration, then the method 300 may proceed to step 314. In step 314, the processing system may determine whether a maintenance window for the mobile network has been detected.

For instance, maintenance windows for maintenance of the mobile network and/or satellite backhaul transport network may be scheduled or predefined, and the processor may have access to the maintenance schedule. Thus, the processing system may monitor the current time, and when the current time coincides with the scheduled start of a maintenance window, may determine that a maintenance window has been detected.

If the processing system concludes in step 314 that a maintenance window has not been detected, then the processing system may repeat step 314 until a maintenance window is detected. For instance, the processing system may continue to monitor the current time and to compare the current time against a schedule of predefined maintenance windows.

If, however, the processing system concludes in step 314 that a maintenance window has been detected, then the method 300 may proceed to step 316. In step 316, the processing system may determine whether the operator of the mobile network has selected an automatic configuration option for the satellite backhaul transport network.

For instance, if the operator elects not to immediately deploy the recommended configuration in order to minimize disruptions to service, the operator may be prompted to further select whether the recommended configuration should be automatically deployed by the processing system during the next scheduled maintenance window, or whether the operator will manually initiate deployment of the recommended configuration (e.g., by sending a signal to the processing system explicitly instructing the processing system to deploy the recommended configuration). In the case where the operator has selected manual initiation, the processing system may send a reminder to the operator (e.g., a visual or audio alert to a device or account associated with the operator) when the next scheduled maintenance window is detected to have been reached. In another example, the processing system may not send a reminder, and may monitor for receipt of a signal from the operator.

If the processing system concludes in step 316 that the operator of the mobile network has selected the automatic configuration option for the satellite backhaul transport network, then the method 300 may proceed to step 320, and the processing system may automatically (i.e., in response to the maintenance window being detected) modify a configuration of the satellite backhaul transport network in accordance with the recommended configuration as discussed above.

If, however, the processing system concludes in step 316 that the operator of the mobile network has not selected the automatic configuration option for the satellite backhaul transport network, then the method 300 may assume that the operator of the mobile network has selected a manual configuration option and may proceed to step 318.

In step 318, the processing system may receive a manual signal from the operator of the mobile network to configure the satellite backhaul network. As discussed above, the manual signal may be received in response to a reminder send by the processing system, or the processing system may send no reminder and simply monitor for receipt of the manual signal. The manual signal may comprise, for example, a press of a button or an area of a touch screen on a device of the operator, which causes an instruction to be sent to the processing system.

The method 300 may then proceed to step 320, and the processing system may (i.e., in response to the manual signal being received from the user) modify a configuration of the satellite backhaul transport network in accordance with the recommended configuration as discussed above. The method 300 may end in step 322.

Although not expressly specified above, one or more steps of the method 200 or method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure deploy a software defined access controller (SDAC) in a mobile network that includes a satellite backhaul transport network. The SDAC includes a machine learning model that is trained to learn the impacts the variations in conditions such as those described above may have on supporting network demand. The machine learning model may then be trained to recommend an optimal configuration for the satellite backhaul transport network (e.g., numbers and locations of new spectrum channels) to support a given network demand, given a set of conditions in the mobile network. Thus, when there is a temporary increase in network demand, as there may be during events such as global sporting events (e.g., Olympics, World Cup, etc.), holidays, natural disasters, and other types of events, a configuration of the satellite backhaul transport network may be automatically recommended and/or implemented to provide the bandwidth needed to support the increase in demand. The machine learning model may also recommend optimal configurations for the satellite backhaul transport network to handle more cyclic changes in network demand (e.g., certain times of day where demand is observed to increase or decrease).

FIG. 4 depicts a high-level block diagram of a computing device specifically programmed to perform the functions described herein. For example, any one or more components or devices illustrated in FIG. 1 or described in connection with the method 200 or method 300 may be implemented as the system 400. For instance, a software defined access controller (such as might be used to perform the method 200 or the method 300) or an application server could be implemented as illustrated in FIG. 4.

As depicted in FIG. 4, the system 400 comprises a hardware processor element 402, a memory 404, a module 405 for allocating a radio frequency spectrum channel for satellite backhaul transport in a mobile network, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for allocating a radio frequency spectrum channel for satellite backhaul transport in a mobile network may include circuitry and/or logic for performing special purpose functions relating to monitoring and quantifying user engagement with a media item based on movements of user facial features. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for allocating a radio frequency spectrum channel for satellite backhaul transport in a mobile network (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for allocating a radio frequency spectrum channel for satellite backhaul transport in a mobile network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
determining, by a processing system including at least one processor, a demand on a mobile network that utilizes a satellite backhaul transport network;
acquiring, by the processing system, a set of values for parameters of the satellite backhaul transport network;
executing, by the processing system, a machine learning model that takes the demand and the set of values as an input and generates as an output a recommended configuration of the satellite backhaul transport network;
presenting, by the processing system, the recommended configuration to an operator of the mobile network; and
modifying, by the processing system in response to an acceptance of the recommended configuration by the operator, a configuration of the satellite backhaul transport network in accordance with the recommended configuration.

2. The method of claim 1, wherein the mobile network comprises a fifth generation cellular network.

3. The method of claim 1, wherein the demand comprises a real-time demand characterized by at least one metric measured in the mobile network.

4. The method of claim 3, wherein the at least one metric comprises at least one of: a volume of network traffic, an origin of the network traffic, a destination of the network traffic, a size of data packets contained in the network traffic, a packet loss of the network traffic, a latency of the network traffic, a bandwidth of the network traffic, a modulation technique, a channel spacing, a forward error correction, a peak data rate, a connection density, an area traffic capacity, a network energy efficiency, a spectral efficiency, a mobility, a number of array antennas, a throughput, a gain profile, an absorption loss, a scattering, an air interface characteristic, a dispersion, a seasonality, a number of hops, or a distance between network elements.

5. The method of claim 1, wherein the demand comprises a projected demand that is projected based on historical trends in demand in the mobile network.

6. The method of claim 1, wherein the parameters of the satellite backhaul transport network comprise at least one of: a distance between a cellular base station of the satellite backhaul transport network and a satellite of the satellite backhaul transport network, a distance between a satellite of the satellite backhaul transport network and a core network satellite gateway of the satellite backhaul transport network, a gain profile of the satellite backhaul transport network, an absorption loss of the satellite backhaul transport network, a scattering of the satellite backhaul transport network, a dispersion profile of the satellite backhaul transport network, or an air interface characteristic of the satellite backhaul transport network.

7. The method of claim 1, wherein the recommended configuration comprises at least one of: a number of new radio frequency spectrum channels to deploy in the mobile network, a location at which to deploy a new radio frequency spectrum channel of the number of new radio frequency spectrum channels, a modulation format for a new radio frequency spectrum channel of the number of new radio frequency spectrum channels, or a modification to a modulation format of an existing radio frequency spectrum channel.

8. The method of claim 7, wherein the modulation format is at least one of: an adaptive forward error correction, a coherent multiple input, a multiple output receiver, a flexible data rate, or a flexible data type.

9. The method of claim 7, wherein the recommended configuration further comprises a modification to at least one parameter of the parameters of the satellite backhaul transport network.

10. The method of claim 1, where the presenting further comprises identifying an impact that a deployment of the recommended configuration is expected to have on the mobile network.

11. The method of claim 10, wherein the impact comprises a disruption to a service to users of the mobile network.

12. The method of claim 1, wherein the modifying is performed during a scheduled maintenance window for the mobile network.

13. The method of claim 12, wherein the modifying is performed automatically in response to a detection of the scheduled maintenance window by the processing system.

14. The method of claim 12, wherein the modifying is performed in response to receiving a manual signal from the operator of the mobile network during the scheduled maintenance window.

15. The method of claim 14, wherein the manual signal is received in response a reminder sent by the processing system to the operator.

16. The method of claim 1, wherein the modifying comprises sending a control signal to at least one component of the satellite backhaul transport network, wherein the control signal causes the at least one component to perform an action to deploy the recommended configuration.

17. The method of claim 1, wherein the machine learning model is trained using a set of training data that includes data collected from the mobile network for various pairs of network elements of the mobile network operating under various combinations of values of the parameters of the satellite backhaul transport network.

18. The method of claim 17, wherein the processing system is configured to learn a topology of the mobile network as part of a training of the machine learning model.

19. A non-transitory computer-readable medium storing instructions which, when executed by a processor, cause the processor to perform operations, the operations comprising:
determining a demand on a mobile network that utilizes a satellite backhaul transport network;
acquiring a set of values for parameters of the satellite backhaul transport network;
executing a machine learning model that takes the demand and the set of values as an input and generates as an output a recommended configuration of the satellite backhaul transport network;
presenting the recommended configuration to an operator of the mobile network; and
modifying, in response to an acceptance of the recommended configuration by the operator, a configuration of the satellite backhaul transport network in accordance with the recommended configuration.

20. A device comprising:
a processor; and
a computer-readable medium storing instructions which, when executed by the processor, cause the processor to perform operations, the operations comprising:
determining a demand on a mobile network that utilizes a satellite backhaul transport network;
acquiring a set of values for parameters of the satellite backhaul transport network;
executing a machine learning model that takes the demand and the set of values as an input and generates as an output a recommended configuration of the satellite backhaul transport network;
presenting the recommended configuration to an operator of the mobile network; and
modifying, in response to an acceptance of the recommended configuration by the operator, a configuration of the satellite backhaul transport network in accordance with the recommended configuration.
